(19) United States
(12) Patent Application Publication
(10) Pub. No.: US 2026/0061686 A1
(43) Pub. Date: Mar. 5, 2026

(54) INJECTION MOLDING APPARATUS AND MOLD CLAMPING DEVICE

(71) Applicant: SEIKO EPSON CORPORATION, Tokyo (JP)

(72) Inventor: Tetsuya TAMURA, MATSUMOTO-SHI (JP)

(21) Appl. No.: 19/310,032

(22) Filed: Aug. 26, 2025

(30) Foreign Application Priority Data
Aug. 28, 2024 (JP) 2024-146393

(51) Int. Cl. B29C 45/76; B29C 45/17; B29C 45/66

(52) U.S. Cl. CPC B29C 45/7653; B29C 45/1703; B29C 45/66

(57) ABSTRACT

An injection molding apparatus includes an injection unit, a mold clamping unit, and a controller. The mold clamping unit includes a toggle fixing portion, a fixed mold attachment portion, a movable mold attachment portion, a motor, a ball screw, a crosshead, and a toggle section configured to move the movable mold attachment portion along a mold clamping direction. The toggle section includes a first member associated with a first rotary shaft, a second member associated with a second rotary shaft and a third rotary shaft, and a third member associated with a fourth rotary shaft. A length of a line connecting a center of the first rotary shaft and a center of the second rotary shaft is equal to or longer than a length of a line connecting a center of the second rotary shaft and a center of the third rotary shaft.

The present application is based on, and claims priority from JP Application Serial Number 2024-146393, filed Aug. 28, 2024, the disclosure of which is hereby incorporated by reference herein in its entirety.

### BACKGROUND

### 1. Technical Field

The present disclosure relates to an injection molding apparatus and a mold clamping device.

### 2. Related Art

JP-A-2017-128014 discloses an injection molding apparatus including a toggle mechanism that opens and closes a metal mold.

JP-A-2017-128014 is an example of the related art.

In order to improve a quality of a molded article molded by injection molding, it is necessary to perform mold clamping of a molding die with appropriate mold clamping force according to a material to be used, a shape of the molded article, and so on. Therefore, there is a demand for a technique capable of precisely adjusting the mold clamping force in the injection molding apparatus including a toggle section that opens and closes the molding die.

### SUMMARY

According to a first aspect of the present disclosure, an injection molding apparatus is provided. The injection molding apparatus is an injection molding apparatus configured to perform injection molding of a molded article using a molding die configured with a fixed mold and a movable mold, the apparatus including an injection unit configured to inject a material of the molded article into the molding die, a mold clamping unit to which the molding die is attached and which is configured to perform mold clamping of the molding die, and a controller configured to control the injection unit and the mold clamping unit, wherein the mold clamping unit includes a toggle fixing portion, a fixed mold attachment portion to which the fixed mold is attached, a movable mold attachment portion which is disposed between the toggle fixing portion and the fixed mold attachment portion so as to be movable forward and backward in a mold clamping direction, and to which the movable mold is attached, a motor, a ball screw attached to the toggle fixing portion and configured to rotate due to driving of the motor, a crosshead configured to move between the toggle fixing portion and the movable mold attachment portion due to rotation of the ball screw, and a toggle section coupled to the toggle fixing portion, the movable mold attachment portion, and the crosshead and configured to move the movable mold attachment portion along the mold clamping direction due to a movement of the crosshead, the toggle section includes a first member coupled to the toggle fixing portion via a first rotary shaft, a second member coupled to the first member via a second rotary shaft, and coupled to the movable mold attachment portion via a third rotary shaft, and a third member coupled to the crosshead and coupled to the first member via a fourth rotary shaft, and a length of a line connecting a center of the first rotary shaft and a center of the second rotary shaft in the first member is equal to or longer than a length of a line connecting a center of the second rotary shaft and a center of the third rotary shaft in the second member.

According to a second aspect of the present disclosure, a mold clamping device is provided. The mold clamping device includes a toggle fixing portion, a fixed mold attachment portion to which a fixed mold a position of which is fixed in a mold clamping operation is attached, a movable mold attachment portion which is disposed between the toggle fixing portion and the fixed mold attachment portion so as to be movable forward and backward in a mold clamping direction, and to which a movable mold which is moved relatively to the fixed mold in the mold clamping operation is attached, a motor, a ball screw attached to the toggle fixing portion and configured to rotate due to driving of the motor, a crosshead configured to move between the toggle fixing portion and the movable mold attachment portion due to rotation of the ball screw, and a toggle section coupled to the toggle fixing portion, the movable mold attachment portion, and the crosshead and configured to move the movable mold attachment portion along the mold clamping direction due to a movement of the crosshead, wherein the toggle section includes a first member coupled to the toggle fixing portion via a first rotary shaft, a second member coupled to the first member via a second rotary shaft, and coupled to the movable mold attachment portion via a third rotary shaft, and a third member coupled to the crosshead and coupled to the first member via a fourth rotary shaft, and a length of a line connecting a center of the first rotary shaft and a center of the second rotary shaft in the first member is equal to or longer than a length of a line connecting a center of the second rotary shaft and a center of the third rotary shaft in the second member.

### BRIEF DESCRIPTION OF THE DRAWINGS

FIG. 1 is a diagram illustrating a schematic configuration of an injection molding apparatus.

FIG. 2 is a cross-sectional view illustrating a schematic configuration of an injection unit.

FIG. 3 is a perspective view illustrating a schematic configuration of a flat screw.

FIG. 4 is a schematic plan view of a barrel.

FIG. 5 is a diagram illustrating a schematic configuration of a mold clamping unit.

FIG. 6 is a flowchart of mold thickness adjustment processing executed by a controller.

FIG. 7 is a diagram showing a state of the mold clamping unit before the mold thickness adjustment processing is executed.

FIG. 8 is a diagram illustrating an operation of the mold clamping unit in the mold thickness adjustment processing.

FIG. 9 is a diagram illustrating the operation of the mold clamping unit in the mold thickness adjustment processing.

FIG. 10 is a diagram illustrating the operation of the mold clamping unit in the mold thickness adjustment processing.

FIG. 11 is a diagram illustrating a position of a crosshead in a state where mold opening of the molding die is performed.

FIG. 12 is a diagram illustrating the position of the crosshead in the state where the mold opening of the molding die is performed when a toggle fixing portion has a recess into which the crosshead cannot be fitted.

FIG. 13 is a diagram showing an example of a toggle section in which the length of a line L1 is longer than the length of a line L2.

FIG. 14 is a diagram showing an example of the toggle section in which the length of the line L1 is shorter than the length of the line L2.

### DESCRIPTION OF EMBODIMENTS

### A. First Embodiment

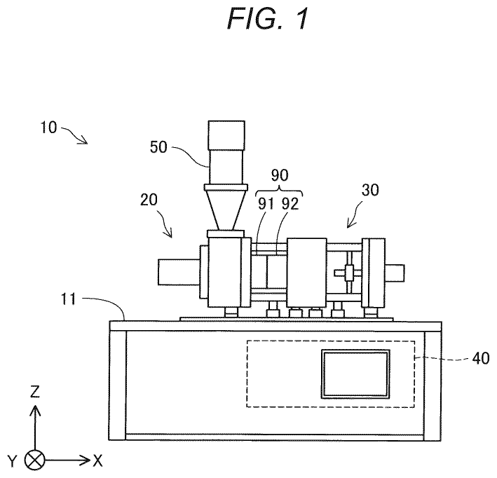

FIG. 1 is a diagram illustrating a schematic configuration of an injection molding apparatus 10. FIG. 1 shows arrows indicating X, Y, and Z directions perpendicular to one another. The X direction and the Y direction are directions parallel to a horizontal plane. The Z direction is a direction parallel to a vertical direction. The X, Y, and Z directions in FIG. 1 and the X, Y, and Z directions in other drawings indicate the same directions. When specifying an orientation, a positive or negative sign is used together with the description of the direction, defining a positive direction which is a direction pointed by an arrow as “+”, and a negative direction which is a direction opposite to the direction pointed by the arrow as “−”.

The injection molding apparatus 10 includes an injection unit 20, a mold clamping unit 30, and a controller 40. The injection molding apparatus 10 performs injection molding of a molded article using a molding die 90 attached to the mold clamping unit 30. The injection unit 20 and the mold clamping unit 30 are fixed on a base 11. The injection molding apparatus 10 is a horizontal injection molding apparatus, and the injection unit 20 and the mold clamping unit 30 are arranged in a horizontal direction. The controller 40 is housed in the base 11.

The controller 40 controls the injection unit 20 and the mold clamping unit 30. The controller 40 is configured with a computer having a single processor or a plurality of processors, a memory, and an input-output interface that inputs and outputs signals from and to the outside. The controller 40 achieves various functions such as a function of executing processing of molding a molded article by the processor executing a program or commands loaded onto a main storage device. Note that the controller 40 may be implemented by a configuration in which a plurality of circuits for realizing at least a part of each of the functions is combined with each other, instead of being configured with a computer.

The molding die 90 made of metal is attached to the mold clamping unit 30. The molding die 90 made of metal is referred to as a metal mold. The molding die 90 includes a fixed mold 91 and a movable mold 92. The fixed mold 91 is a mold the position of which is fixed in a mold clamping operation. The movable mold 92 is a mold that is moved relatively to the fixed mold 91 in the mold clamping operation. The movable mold 92 is moved in a mold clamping direction with respect to the fixed mold 91 by the mold clamping unit 30. In the present embodiment, the mold clamping direction is the −X direction. The molding die 90 is not limited to one made of metal, and may be one made of resin or ceramic. In the present specification, the mold clamping unit 30 is also referred to as a mold clamping device.

A hopper 50 into which a material for the molded article is put is coupled to the injection unit 20. As the material for the molded article, thermoplastic resin formed in a pellet shape is used. As the thermoplastic resin, acrylonitrile butadiene styrene (ABS), polycarbonate (PC), polyacetal (POM), polypropylene (PP), polybutylene terephthalate (PBT), and the like are used. The material for the molded article may contain metal or ceramic in addition to the thermoplastic resin. The supply of the material to the injection unit 20 is not limited to the supply from the hopper 50 but may be performed, for example, via a tube through which the material is pumped.

The injection unit 20 plasticizes at least a part of the material supplied from the hopper 50 to generate a molding material, and injects the molding material thus generated into the molding die 90. In the present specification, “plasticizing” refers to a concept including melting, and means changing from a solid to a state having fluidity. Specifically, in the case of a material in which glass transition occurs, plasticizing refers to setting the temperature of the material to the glass transition point or higher. In the case of a material in which glass transition does not occur, plasticizing means setting the temperature of the material to the melting point or higher.

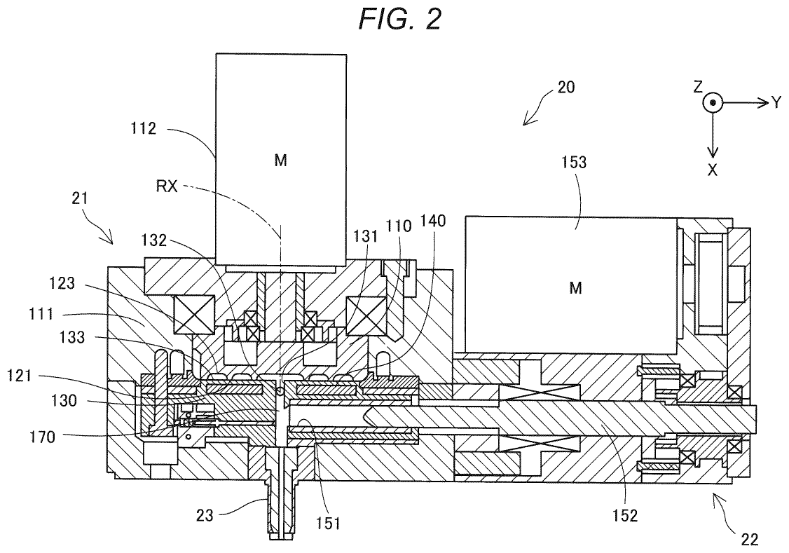

FIG. 2 is a cross-sectional view illustrating a schematic configuration of the injection unit 20. The injection unit 20 includes a plasticizing unit 21, a suction feeding unit 22, and a nozzle 23.

The plasticizing unit 21 plasticizes at least a part of the material supplied from the hopper 50 to generate the molding material. The plasticizing unit 21 includes a flat screw 110, a barrel 130, and a heater 140. The flat screw 110 is housed in a screw case 111. The flat screw 110 is also called a rotor or simply called a screw. The flat screw 110 is rotationally driven by a drive motor 112 about a rotational axis RX inside the screw case 111. In the present embodiment, a direction of the rotational axis RX is along the X direction. The communication hole 131 is formed at the center of the barrel 130. The communication hole 131 forms at least a part of a flow path 170 through which the molding material flows. An injection cylinder 151 described later is coupled to the communication hole 131. The communication hole 131 is provided with a check valve 132 upstream of the injection cylinder 151. A rotation of the flat screw 110 by the drive motor 112 and heating by the heater 140 are controlled by the controller 40.

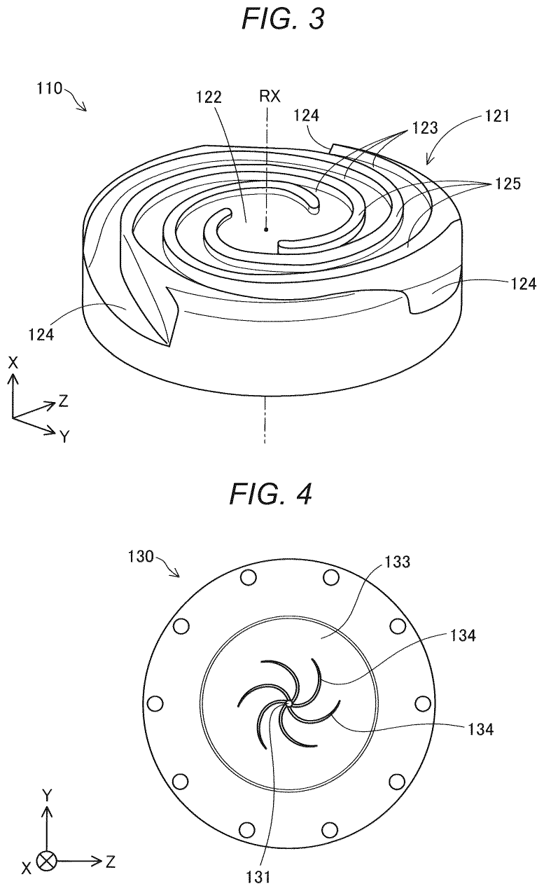

FIG. 3 is a perspective view illustrating a schematic configuration of the flat screw 110. The flat screw 110 has a substantially cylindrical shape having a height in a direction along the center axis thereof smaller than the diameter. On a groove forming surface 121 of the flat screw 110 facing the barrel 130, spiral grooves 123 are formed centering on a central portion 122. The grooves 123 communicate with a material inlet 124 provided to a side surface of the flat screw 110. A material supplied from the hopper 50 is supplied to the grooves 123 through the material inlet 124. The grooves 123 are formed by being partitioned by convex ridges 125. FIG. 3 illustrates an example in which three grooves 123 are formed, but the number of grooves 123 may be one or may be two or more. Note that the shape of the groove 123 is not limited to a spiral shape and may be a helical shape or an involute curve shape or may be a shape extending so as to draw an arc from the central portion 122 toward the outer circumference.

FIG. 4 is a schematic plan view of the barrel 130. The barrel 130 has an opposed surface 133 opposed to the groove forming surface 121 of the flat screw 110. The communication hole 131 is formed at the center of the opposed surface 133. A plurality of guide grooves 134 coupled to the communication hole 131 and extending in a spiral shape from the communication hole 131 toward the outer circumference is formed on the opposed surface 133. The material supplied to the grooves 123 of the flat screw 110 flows along the grooves 123 and the guide grooves 134 due to a rotation of the flat screw 110 while being plasticized between the flat screw 110 and the barrel 130 by the rotation of the flat screw 110 and heating by the heater 140, and is guided to the central portion 122 of the flat screw 110. The material flowing in the central portion 122 flows out to the suction feeding unit 22 from the communication hole 131 formed at the center of the barrel 130. Note that the guide grooves 134 are not required to be provided to the barrel 130. Further, the guide grooves 134 are not required to be coupled to the communication hole 131.

As shown in FIG. 2, the suction feeding unit 22 includes an injection cylinder 151, a plunger 152, and a plunger driver 153. The suction feeding unit 22 has a function of injecting the molding material located in the injection cylinder 151 into a cavity defined between the fixed mold 91 and the movable mold 92. The suction feeding unit 22 controls an injection amount, an injection speed, and injection pressure of the molding material injected from the nozzle 23 under the control of the controller 40. The injection cylinder 151 is a substantially cylindrical member coupled to the communication hole 131 of the barrel 130 and has the plunger 152 inside. The plunger 152 slides inside the injection cylinder 151 and pumps the molding material located in the injection cylinder 151 to the nozzle 23 provided to the injection unit 20. The plunger 152 is driven by the plunger driver 153 configured with a motor.

The flow path 170 is provided to the nozzle 23. By the plunger 152 pressure-feeding the molding material located in the injection cylinder 151 to the nozzle 23, the molding material is injected from the nozzle 23 to the molding die 90. The nozzle 23 may be configured as an open gate type nozzle or may be configured as a valve gate type nozzle.

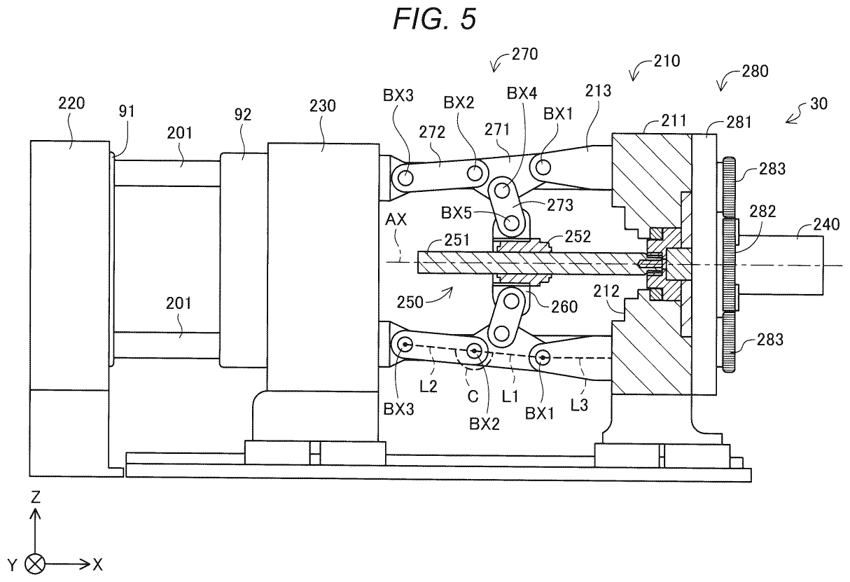

FIG. 5 is a diagram illustrating a schematic configuration of the mold clamping unit 30. The mold clamping unit 30 performs the mold clamping of the molding die 90 attached to the mold clamping unit 30. The mold clamping unit 30 includes a toggle fixing portion 210, a fixed mold attachment portion 220, a movable mold attachment portion 230, a motor 240, a ball screw 250, a crosshead 260, a toggle section 270, and a fixing plate moving section 280.

The fixed mold attachment portion 220 is fixed to end portions at the −X direction side of tie bars 201 extending in the X direction. The fixed mold 91 is attached to the fixed mold attachment portion 220. The toggle fixing portion 210 is disposed at the +X direction side of the fixed mold attachment portion 220 so as to be movable along an extending direction of the tie bars 201. The movable mold attachment portion 230 is disposed between the fixed mold attachment portion 220 and the toggle fixing portion 210 so as to be movable along the extending direction of the tie bars 201. That is, the toggle fixing portion 210 and the movable mold attachment portion 230 are disposed so as to be movable forward and backward in the mold clamping direction. The movable mold 92 is attached to the movable mold attachment portion 230 so as to face the fixed mold 91.

The toggle fixing portion 210 includes a fixing plate 211, a recess 212, and a coupling portion 213. The fixing plate 211 is disposed so as to face the movable mold attachment portion 230 across the toggle section 270. The recess 212 is provided to a surface at the movable mold attachment portion 230 side of the fixing plate 211 so that at least a part of the crosshead 260 described later can be fitted. The coupling portion 213 is disposed so as to protrude from the fixing plate 211 toward the −X direction, which is the mold clamping direction. The coupling portion 213 is disposed symmetrically about a horizontal plane including an axis AX of a screw shaft 251 described later.

The motor 240 rotates the ball screw 250 described later. The motor 240 is, for example, a servomotor. The motor 240 is controlled by the controller 40.

The ball screw 250 is disposed between the toggle fixing portion 210 and the movable mold attachment portion 230. The ball screw 250 includes the screw shaft 251 and a nut 252. The screw shaft 251 is attached to the recess 212 of the toggle fixing portion 210 so as to protrude from the fixing plate 211 in the −X direction. The screw shaft 251 is coupled to an output shaft of the motor 240 via a coupling. The screw shaft 251 rotates around an axis AX of the screw shaft 251 due to driving of the motor 240. The axis AX is along the X direction. The nut 252 is disposed to be movable along the screw shaft 251, and moves in the X direction with the rotation of the screw shaft 251. The crosshead 260 is coupled to the nut 252. A part of the nut 252 protrudes toward the toggle fixing portion 210 with respect to the crosshead 260 and does not protrude toward the movable mold attachment portion 230 with respect to the crosshead 260.

The crosshead 260 is fixed to the nut 252. Therefore, when the nut 252 moves in the X direction with the rotation of the screw shaft 251, the crosshead 260 also moves in the X direction together with the nut 252. That is, the crosshead 260 moves in the X direction between the toggle fixing portion 210 and the movable mold attachment portion 230 due to the rotation of the ball screw 250.

The toggle section 270 is coupled to the toggle fixing portion 210, the movable mold attachment portion 230, and the crosshead 260. The toggle section 270 includes a first member 271, a second member 272, and a third member 273. The first member 271, the second member 272, and the third member 273 are disposed symmetrically about a horizontal plane including the axis AX of the screw shaft 251.

The first member 271 is coupled to the coupling portion 213 of the toggle fixing portion 210 via the first rotary shaft BX1. An axis of the first rotary shaft BX1 is along the Y direction. The first member 271 is disposed so as to be rotatable about the first rotary shaft BX1 in the X-Z plane. The first member 271 is also called a crank.

One end of the second member 272 is coupled to the first member 271 via a second rotary shaft BX2, and the other end thereof is coupled to the movable mold attachment portion 230 via a third rotary shaft BX3. Axes of the second rotary shaft BX2 and the third rotary shaft BX3 are along the Y direction. The second member 272 is disposed so as to be rotatable relatively to the first member 271 in the X-Z plane about the second rotary shaft BX2. In addition, the second member 272 is disposed so as to be rotatable relatively to the movable mold attachment portion 230 in the X-Z plane about the third rotary shaft BX3. The second member 272 is also called a connecting rod.

One end of the third member 273 is coupled to the first member 271 via a fourth rotary shaft BX4, and the other end thereof is coupled to the crosshead 260 via a fifth rotary shaft BX5. Axes of the fourth rotary shaft BX4 and the fifth rotary shaft BX5 are along the Y direction. The third member 273 is disposed so as to be rotatable relatively to the first member 271 in the X-Z plane about the fourth rotary shaft BX4. In addition, the third member 273 is disposed so as to be rotatable relatively to the crosshead 260 in the X-Z plane about the fifth rotary shaft BX5. The third member 273 is also called a link.

The length of a line L1 connecting the center of the first rotary shaft BX1 and the center of the second rotary shaft BX2 in the first member 271 is equal to or longer than the length of a line L2 connecting the center of the second rotary shaft BX2 and the center of the third rotary shaft BX3 in the second member 272. FIG. 5 shows when the length of the line L1 is equal to the length of the line L2. Further, the length of a line L3 connecting an end portion of the coupling portion 213 in contact with the fixing plate 211 and the center of the first rotary shaft BX1 is longer than the length of the line L1. Here, the line L3 is along the X direction.

When the crosshead 260 moves in the −X direction, the members of the toggle section 270 rotate about the respective rotary shafts, so that the movable mold attachment portion 230 moves in the −X direction. Thus, the mold clamping of the molding die 90 is performed. When the crosshead 260 moves in the +X direction, the members of the toggle section 270 rotate about the respective rotary shafts, so that the movable mold attachment portion 230 moves in the +X direction. Thus, the mold opening of the molding die 90 is performed. In other words, the toggle section 270 moves the movable mold attachment portion 230 along the mold clamping direction due to the movement of the crosshead 260. Hereinafter, the rotations of the members of the toggle section 270 about the respective rotary shafts are also referred to as an operation of the toggle section 270.

The fixing plate moving section 280 moves the toggle fixing portion 210 along the mold clamping direction. The fixing plate moving section 280 includes a base portion 281, a first gear 282, second gears 283, and a fixing plate moving motor (not illustrated). The base portion 281 is attached to the +X direction side of the fixing plate 211. The first gear 282 and the second gears 283 are attached to the +X direction side of the base portion 281 such that axes thereof are along the X direction. The first gear 282 is coupled to the fixing plate moving motor, and rotates around an axis of the first gear 282 due to driving of the fixing plate moving motor. The fixing plate moving motor is controlled by the controller 40. The second gears 283 mesh with the first gear 282. The second gear 283 has a through hole penetrating the second gear 283 in the X direction. A screw thread is formed on an inner surface of the through hole. The tie bar 201 is located in the through hole. The screw thread on the inner surface of the through hole is screwed into a screw groove formed on a surface of the tie bar 201. Therefore, when the first gear 282 rotates about the axis of the first gear 282, the second gears 283 rotate about the respective axes, and the fixing plate moving section 280 moves in the X direction along the tie bars 201. Accordingly, the toggle fixing portion 210, the motor 240, the ball screw 250, the crosshead 260, the toggle section 270, and the movable mold attachment portion 230 integrally move in the X direction together with the fixing plate moving section 280.

The controller 40 makes the toggle section 270 operate to thereby perform the mold clamping and the mold opening of the fixed mold 91 and the movable mold 92 by driving the motor 240 to control the position of the crosshead 260. Further, the controller 40 moves the toggle fixing portion 210 to adjust the mold clamping force by driving the fixing plate moving motor to control the position of the fixing plate moving section 280.

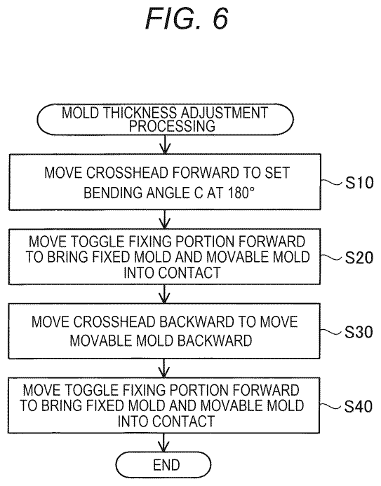

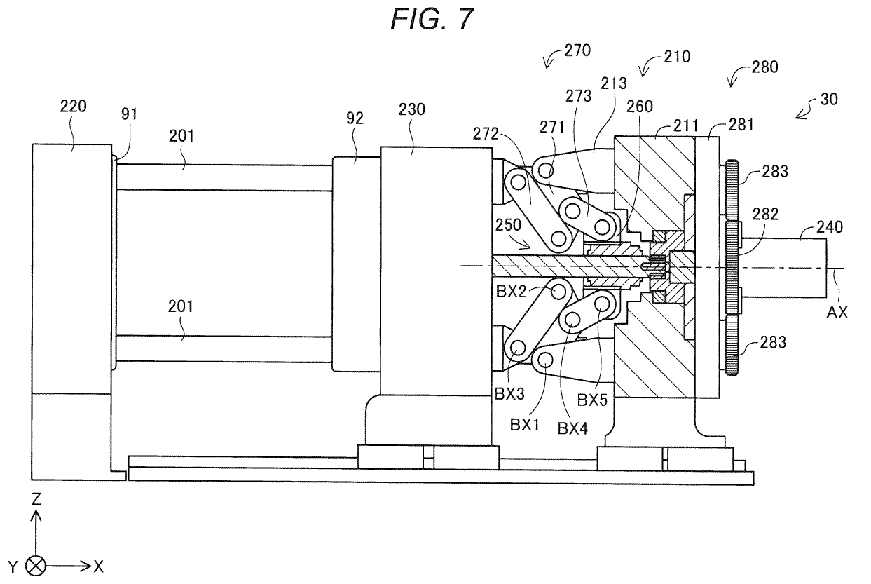

FIG. 6 is a flowchart of mold thickness adjustment processing executed by the controller 40. The mold thickness adjustment processing is processing to be executed in order to adjust the mold clamping force during mold clamping. The mold thickness adjustment processing is executed when the molding die 90 is mounted on the mold clamping unit 30 for the first time and when the molding die 90 mounted on the mold clamping unit 30 is replaced. FIGS. 7 to 10 are diagrams illustrating the operation of the mold clamping unit 30 in the mold thickness adjustment processing. The mold thickness adjustment processing will hereinafter be described with reference to FIGS. 5 to 10. Hereinafter, a movement of each part of the mold clamping unit 30 in the −X direction, which is the mold clamping direction, is also referred to as “moving forward”, and the movement in the +X direction, which is the opposite direction to the mold clamping direction, is also referred to as “moving backward”.

FIG. 7 shows a state of the mold clamping unit 30 before the mold thickness adjustment processing is executed. Before the mold thickness adjustment processing is executed, the fixed mold 91 and the movable mold 92 are separated from each other.

In step S10 in FIG. 6, the controller 40 drives the motor 240 to move the crosshead 260 forward to a position where a first bending angle C is 180°. Here, the first bending angle C is an angle at a far side from the ball screw 250 in the Z direction in the angle between the line L1 and the line L2. FIG. 5 illustrates a state where step S10 is executed and the first bending angle C is 180°. Note that the controller 40 is not required to move the crosshead 260 forward to a position where the first bending angle C is completely 180°. The controller 40 preferably moves the crosshead 260 forward to a position where the first bending angle C is no less than 1790 and no more than 180°.

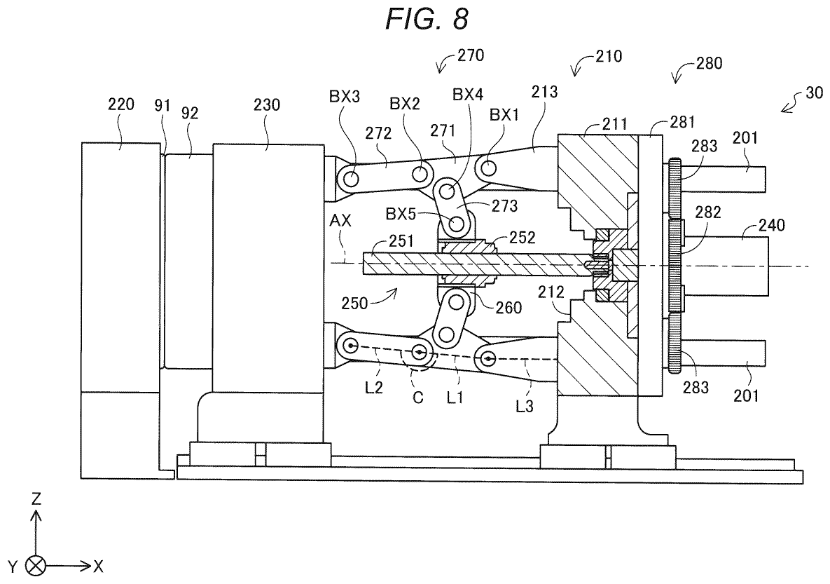

In step S20, the controller 40 drives the fixing plate moving motor to move the toggle fixing portion 210 forward to a position where the fixed mold 91 and the movable mold 92 come into contact with each other. FIG. 8 illustrates a state in which step S20 is executed and the fixed mold 91 and the movable mold 92 are in contact with each other. In step S20, the controller 40 does not change the position of the crosshead 260. Therefore, the first bending angle C in step S20 is equal to the first bending angle C in step S10.

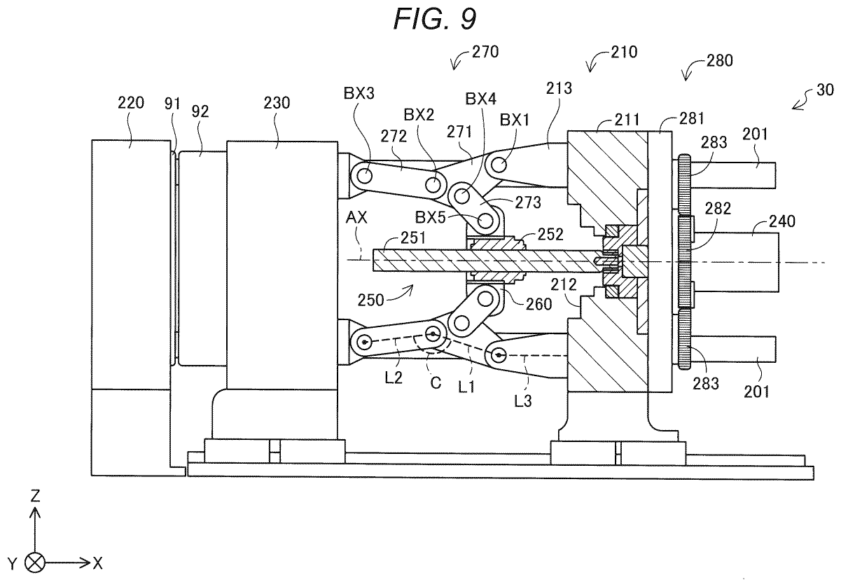

In step S30, the controller 40 drives the motor 240 to move the crosshead 260 backward such that the movable mold attachment portion 230 moves backward by a predetermined amount of backward movement. The predetermined amount of backward movement is determined by the thickness, the shape, and so on of the molding die 90 attached to the mold clamping unit 30. Accordingly, the movable mold 92 moves backward by the predetermined amount of backward movement, and the fixed mold 91 and the movable mold 92 are separated from each other. FIG. 9 illustrates a state in which step S30 is executed and the movable mold 92 has moved backward. As shown in FIG. 9, by the crosshead 260 moving backward, the first bending angle C is smaller than 180°. On this occasion, the first bending angle C is preferably no less than 1500 and no more than 175°.

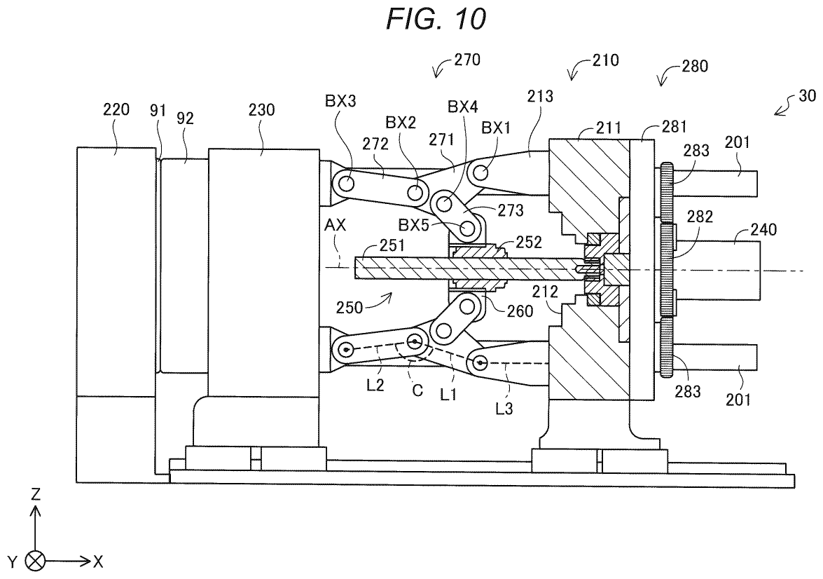

In step S40, the controller 40 drives the fixing plate moving motor to move the toggle fixing portion 210 forward to the position where the fixed mold 91 and the movable mold 92 come into contact with each other. FIG. 10 illustrates a state in which step S40 is executed and the fixed mold 91 and the movable mold 92 are in contact with each other. In step S40, the controller 40 does not change the position of the crosshead 260. Therefore, the first bending angle C in step S40 is equal to the first bending angle C in step S30. The position of the toggle fixing portion 210 in a direction along the mold clamping direction is fixed to the position when step S40 is completed. In such a manner as described above, the mold thickness adjustment processing is executed.

After the mold thickness adjustment processing described above is executed, injection molding of the molded article is performed. In the injection molding of the molded article, the controller 40 drives the motor 240 in the state shown in FIG. 10 to move the crosshead 260 forward to the position where the first bending angle C is 180°. As a result, the mold clamping of the fixed mold 91 and the movable mold 92 is performed at high pressure. In the state where the mold clamping of the fixed mold 91 and the movable mold 92 is performed at high pressure, the injection unit 20 injects the molding material into the molding die 90.

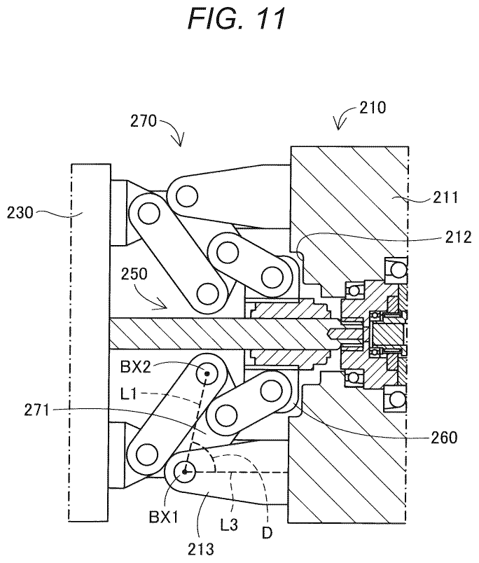

After the injection molding of the molded article is performed, the mold opening of the molding die 90 is performed. The controller 40 performs the mold opening of the molding die 90 by driving the motor 240 to move the crosshead 260 backward. FIG. 11 is a diagram illustrating the position of the crosshead 260 in a state where the mold opening of the molding die 90 is performed. As shown in FIG. 11, in the state where the molding die 90 is opened, a part of the nut 252 protruding toward the toggle fixing portion 210 and a part of the crosshead 260 are fitted into the recess 212. In a state where mold opening of the molding die 90 is performed, the crosshead 260 is located the closest to the toggle fixing portion 210. That is, when the crosshead 260 is located the closest to the toggle fixing portion 210, a part of the crosshead 260 is fitted into the recess 212. Note that when the crosshead 260 is located the closest to the toggle fixing portion 210, the whole of the crosshead 260 may be fitted into the recess 212.

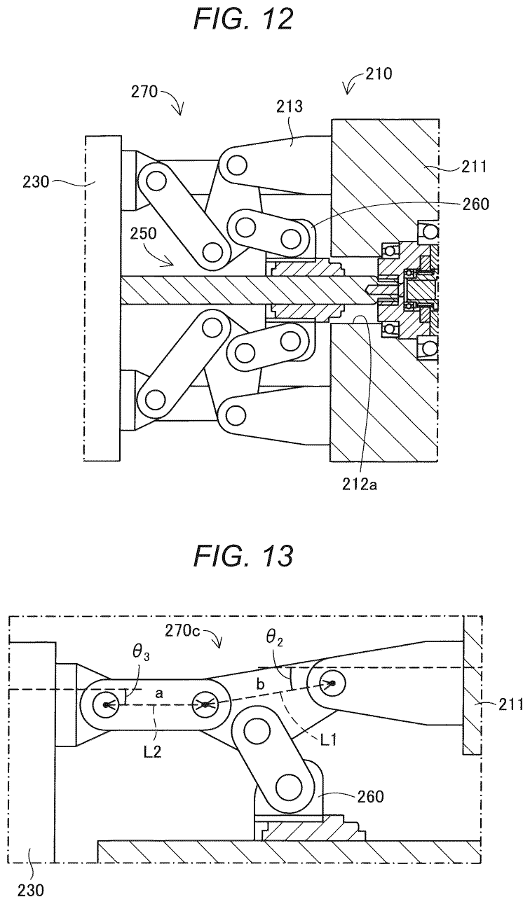

FIG. 12 is a diagram illustrating the position of the crosshead 260 in the state where the mold opening of the molding die 90 is performed when the toggle fixing portion 210 has a recess 212a into which the crosshead 260 cannot be fitted. In this case, in the state where the mold opening of the molding die 90 is performed, a part of the nut 252 protruding toward the toggle fixing portion 210 is fitted into the recess 212a, but the crosshead 260 is not fitted into the recess 212a. Therefore, when the toggle fixing portion 210 has the recess 212 into which at least a part of the crosshead 260 can be fitted as shown in FIG. 11, the amount of backward movement of the crosshead 260 when the mold opening is performed is larger than when the toggle fixing portion 210 has the recess 212a into which the crosshead 260 cannot be fitted.

According to the first embodiment described hereinabove, the length of a line L1 connecting the center of the first rotary shaft BX1 and the center of the second rotary shaft BX2 in the first member 271 is equal to or longer than the length of a line L2 connecting the center of the second rotary shaft BX2 and the center of the third rotary shaft BX3 in the second member 272. When the length of the line L1 is equal to or longer than the length of the line L2 as in the present embodiment, the mold clamping force when the injection molding of the molded article is performed can be adjusted more precisely than when the length of the line L1 is shorter than the length of the line L2. The reason will be described below. Note that the mold clamping force when injection molding of a molded article is performed is hereinafter referred to simply as mold clamping force.

The mold clamping force is determined by the amount of backward movement of the movable mold attachment portion 230 that moves backward in step S30 of the mold thickness adjustment processing. Therefore, in order to precisely adjust the mold clamping force, it is necessary to precisely adjust the amount of backward movement of the movable mold attachment portion 230 in step S30. Since the movable mold attachment portion 230 moves backward by the toggle section 270 operating due to the crosshead 260 moving backward, the smaller the amount of backward movement of the movable mold attachment portion 230 to the amount of backward movement of the crosshead 260 is, the more precisely the amount of backward movement of the movable mold attachment portion 230 can be adjusted.

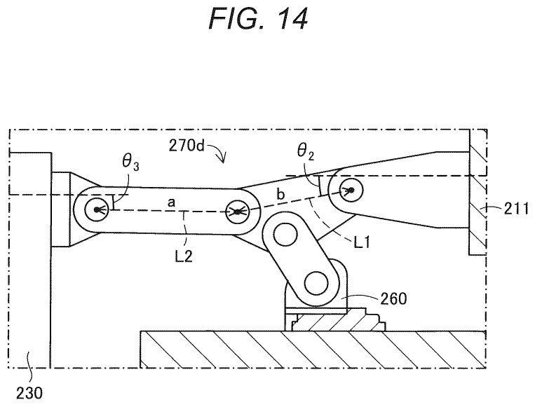

Hereinafter, the amount of backward movement of the movable mold attachment portion 230 when the crosshead 260 is moved backward by the same amount of backward movement when the length of the line L1 is longer than the length of the line L2 and the amount of backward movement of the movable mold attachment portion 230 when the crosshead 260 is moved backward by the same amount of backward movement when the length of the line L1 is shorter than the length of the line L2 will be described citing specific examples. Hereinafter, the length of the line L1 is denoted by “b”, and the length of the line L2 is denoted by “a”. FIG. 13 is a diagram illustrating an example of a toggle section 270c in which the length “b” of the line L1 is longer than the length “a” of the line L2. In FIG. 13, a=50 mm and b=65 mm are assumed. FIG. 14 is a diagram illustrating an example of a toggle section 270d in which the length “b” of the line L1 is shorter than the length “a” of the line L2. In FIG. 14, a=80 mm and b=65 mm are assumed.

The amount of backward movement xp of the movable mold attachment portion 230 when the crosshead 260 moves backward by the amount of backward movement x from the position where the first bending angle C is 180° is expressed by the following formula (1).

$$xp = ( a + b ) cos {θ}_{1} - b cos {θ}_{2} - cos {θ}_{3} \qquad ( 1 )$$

In the formula (1), θ₂ is an angle between the X direction, which is a direction along the mold clamping direction, and a direction along the line L1 in a state where the crosshead 260 moves backward by the amount of backward movement x. θ₁ is an angle between the X direction, which is a direction along the mold clamping direction, and a direction along the line L1 when the first bending angle C is 180°, that is, before the crosshead 260 moves backward. θ₃ is an angle between the X direction, which is a direction along the mold clamping direction, and a direction along the line L2 in the state where the crosshead 260 moves backward by the amount of backward movement x. θ₁, θ₂, and θ₃ are determined by the length “b” of the line L1, the length “a” of the line L2, and the amount of backward movement x of the crosshead 260.

Hereinafter, in the examples shown in FIGS. 13 and 14, the amount of backward movement xp of the movable mold attachment portion 230 when the crosshead 260 moves backward by 10 mm from the position where the first bending angle C is 1800 is calculated. First, in the example illustrated in FIG. 13, a=50 mm, b=65 mm, and x=10 mm are assumed. On this occasion, θ₁=5.5°, θ₂=9.7°, and θ₃=0.07° are obtained. Substituting these values into the formula (1) yields xp=0.3998 mm. That is, when the length of the line L1 is 65 mm, the length of the line L2 is 50 mm, and the amount of backward movement of the crosshead 260 is 10 mm, the amount of backward movement xp of the movable mold attachment portion 230 is 0.3998 mm. Then, in the example shown in FIG. 14, a=80 mm, b=65 mm, and x=10 mm are assumed. On this occasion, θ₁=5.5°, θ₂=11.2°, and θ₃=1.2° are obtained. Substituting these values into the formula (1) yields xp=0.5879 mm. That is, when the length of the line L1 is 65 mm, the length of the line L2 is 80 mm, and the amount of backward movement of the crosshead 260 is 10 mm, the amount of backward movement xp of the movable mold attachment portion 230 is 0.5879 mm. Therefore, the amount of backward movement of the movable mold attachment portion 230 when the crosshead 260 moves backward by the same amount of backward movement is smaller when the length of the line L1 is longer than the length of the line L2, than when the length of the line L1 is shorter than the length of the line L2. Therefore, when the length of the line L1 is equal to or longer than the length of the line L2, the mold clamping force can be adjusted more precisely than when the length of the line L1 is shorter than the length of the line L2.

Further, in the present embodiment, the toggle fixing portion 210 is provided with the recess 212 into which at least a part of the crosshead 260 can be fitted. Therefore, the amount of backward movement of the crosshead 260 in the mold opening can be increased compared to when the recess 212 is not provided to the toggle fixing portion 210. Thus, an opening amount and a closing amount of the molding die 90 can be increased.

Further, in the present embodiment, when the crosshead 260 is located the closest to the toggle fixing portion 210, at least a part of the crosshead 260 is fitted into the recess 212. Therefore, the amount of backward movement of the crosshead 260 in the mold opening can be increased compared to when the recess 212 is not provided to the toggle fixing portion 210. Thus, an opening amount and a closing amount of the molding die 90 can be increased.

Further, in the present embodiment, the length of the line L3 connecting the end portion of the coupling portion 213 in contact with the fixing plate 211 and the center of the first rotary shaft BX1 is longer than the length of the line L1 connecting the center of the first rotary shaft BX1 and the center of the second rotary shaft BX2 in the first member 271. When the length of the line L3 is longer than the length of the line L1, the first member 271 can rotate about the first rotary shaft BX1 until a second bending angle D becomes a smaller angle when the crosshead 260 moves backward, compared to when the length of the line L3 is shorter than the length of the line L1. Here, the second bending angle D is an angle at a near side to the ball screw 250 in the Z direction in the angle between the line L1 and the line L3 as illustrated in FIG. 11. Therefore, in the present embodiment, the amount of backward movement of the crosshead 260 at the time of mold opening can be increased compared to when the length of the line L3 is shorter than the length of the line L1. Thus, an opening amount and a closing amount of the molding die 90 can be increased.

Further, in the present embodiment, a part of the nut 252 protrudes toward the toggle fixing portion 210 with respect to the crosshead 260 and does not protrude toward the movable mold attachment portion 230 with respect to the crosshead 260. Therefore, the possibility that the nut 252 interferes with a member such as the toggle section 270 can be reduced compared to when a part of the nut 252 protrudes toward the movable mold attachment portion 230 with respect to the crosshead 260.

Further, in the present embodiment, the controller 40 controls the fixing plate moving section 280 to move the toggle fixing portion 210 to adjust the mold clamping force. Therefore, the mold clamping force can be adjusted to a mold clamping force appropriate for the molding die 90 attached to the mold clamping unit 30. Further, the mold clamping force can also be adjusted when the molding die 90 attached to the mold clamping unit 30 is replaced and the thickness or the shape of the molding die 90 is changed. Therefore, the mold clamping can appropriately be performed.

### B. Other Embodiments

(B-1) In the embodiment described above, the toggle fixing portion 210 is provided with the recess 212 into which at least a part of the crosshead 260 can be fitted. In contrast, the recess 212 is not required to be provided to the toggle fixing portion 210.

(B-2) In the embodiment described above, when the crosshead 260 is located the closest to the toggle fixing portion 210, at least a part of the crosshead 260 is fitted into the recess 212. In contrast, when the crosshead 260 is located the closest to the toggle fixing portion 210, the crosshead 260 is not required to be fitted into the recess 212.

(B-3) In the embodiment described above, the length of the line L3 connecting the end portion of the coupling portion 213 in contact with the fixing plate 211 and the center of the first rotary shaft BX1 is longer than the length of the line L1 connecting the center of the first rotary shaft BX1 and the center of the second rotary shaft BX2 in the first member 271. In contrast, the length of the line L3 is not required to be longer than the length of the line L1.

(B-4) In the embodiment described above, a part of the nut 252 protrudes toward the toggle fixing portion 210 with respect to the crosshead 260 and does not protrude toward the movable mold attachment portion 230 with respect to the crosshead 260. In contrast, a part of the nut 252 is not required to protrude toward the toggle fixing portion 210 with respect to the crosshead 260. Further, a part of the nut 252 may protrude toward the movable mold attachment portion 230 with respect to the crosshead 260.

(B-5) In the embodiment described above, the mold clamping unit 30 includes the fixing plate moving section 280, and the controller 40 controls the fixing plate moving section 280 to move the toggle fixing portion 210 to adjust the mold clamping force. In contrast, the mold clamping unit 30 is not required to include the fixing plate moving section 280.

### C. Other Aspects

The present disclosure is not limited to the embodiments described above, and can be implemented in various aspects without departing from the scope or the spirit of the present disclosure. For example, the present disclosure can also be implemented in the following aspects. In order to solve a part of or all of the problems of the present disclosure, or to achieve a part of or all of the advantages of the present disclosure, the technical features of the above embodiments corresponding to technical features in each of the following aspects can be replaced or combined as appropriate. In addition, the technical features can be deleted as appropriate unless described as essential features in the present specification.

(1) According to a first aspect of the present disclosure, an injection molding apparatus is provided. The injection molding apparatus is an injection molding apparatus configured to perform injection molding of a molded article using a molding die configured with a fixed mold and a movable mold, the apparatus including an injection unit configured to inject a material of the molded article into the molding die, a mold clamping unit to which the molding die is attached and which is configured to perform mold clamping of the molding die, and a controller configured to control the injection unit and the mold clamping unit, wherein the mold clamping unit includes a toggle fixing portion, a fixed mold attachment portion to which the fixed mold is attached, a movable mold attachment portion which is disposed between the toggle fixing portion and the fixed mold attachment portion so as to be movable forward and backward in a mold clamping direction, and to which the movable mold is attached, a motor, a ball screw attached to the toggle fixing portion and configured to rotate due to driving of the motor, a crosshead configured to move between the toggle fixing portion and the movable mold attachment portion due to rotation of the ball screw, and a toggle section coupled to the toggle fixing portion, the movable mold attachment portion, and the crosshead and configured to move the movable mold attachment portion along the mold clamping direction due to a movement of the crosshead, the toggle section includes a first member coupled to the toggle fixing portion via a first rotary shaft, a second member coupled to the first member via a second rotary shaft, and coupled to the movable mold attachment portion via a third rotary shaft, and a third member coupled to the crosshead and coupled to the first member via a fourth rotary shaft, and a length of a line connecting a center of the first rotary shaft and a center of the second rotary shaft in the first member is equal to or longer than a length of a line connecting a center of the second rotary shaft and a center of the third rotary shaft in the second member.

According to such an aspect, compared to when the length of the line connecting the center of the first rotary shaft and the center of the second rotary shaft in the first member is less than the length of the line connecting the center of the second rotary shaft and the center of the third rotary shaft in the second member, the amount of backward movement of the movable mold attachment portion to the amount of backward movement of the crosshead can be reduced. Since the mold clamping force is determined by the amount of backward movement of the movable mold attachment portion, according to such an aspect, the mold clamping force when injection molding of a molded article is performed can precisely be adjusted.

(2) In the aspect described above, the toggle fixing portion may be provided with a recess into which at least a part of the crosshead can be fitted.

According to such an aspect, the amount of backward movement of the crosshead when mold opening is performed can be increased compared when the recess is not provided to the toggle fixing portion.

(3) In the aspect described above, at least a part of the crosshead may be fitted into the recess when the crosshead is located closest to the toggle fixing portion.

According to such an aspect, the amount of backward movement of the crosshead when mold opening is performed can be increased compared when the recess is not provided to the toggle fixing portion.

(4) In the aspect described above, the toggle fixing portion may include a fixing plate, and a coupling portion disposed so as to protrude from the fixing plate toward the mold clamping direction and coupled to the first member via the first rotary shaft, and a length of a line connecting an end portion of the coupling portion in contact with the fixing plate and the center of the first rotary shaft may be longer than the length of the line connecting the center of the first rotary shaft and the center of the second rotary shaft in the first member.

According to such an aspect, the amount of backward movement of the crosshead at the time of mold opening can be increased compared to when the length of the line connecting the end portion of the coupling portion in contact with the fixing plate and the center of the first rotary shaft is shorter than the length of the line connecting the center of the first rotary shaft and the center of the second rotary shaft in the first member.

(5) In the aspect described above, the ball screw may include a screw shaft, and a nut disposed so as to be movable along the screw shaft and coupled to the crosshead, and a part of the nut may protrude toward the toggle fixing portion with respect to the crosshead and may not protrude toward the movable mold attachment portion with respect to the crosshead.

According to such an aspect, the possibility that the nut interferes with a member such as the toggle section can be reduced compared to when a part of the nut protrudes toward the movable mold attachment portion with respect to the crosshead.

(6) In the aspect described above, the mold clamping unit may include a fixing plate moving section configured to move the toggle fixing portion along the mold clamping direction, and the controller may control the fixing plate moving section to move the toggle fixing portion to adjust mold clamping force.

According to such an aspect, the mold clamping force can be adjusted to mold clamping force appropriate for the molding die mounted on the mold clamping unit.

(7) According to a second aspect of the present disclosure, a mold clamping device is provided. The mold clamping device includes a toggle fixing portion, a fixed mold attachment portion to which a fixed mold a position of which is fixed in a mold clamping operation is attached, a movable mold attachment portion which is disposed between the toggle fixing portion and the fixed mold attachment portion so as to be movable forward and backward in a mold clamping direction, and to which a movable mold which is moved relatively to the fixed mold in the mold clamping operation is attached, a motor, a ball screw attached to the toggle fixing portion and configured to rotate due to driving of the motor, a crosshead configured to move between the toggle fixing portion and the movable mold attachment portion due to rotation of the ball screw, and a toggle section coupled to the toggle fixing portion, the movable mold attachment portion, and the crosshead and configured to move the movable mold attachment portion along the mold clamping direction due to a movement of the crosshead, wherein the toggle section includes a first member coupled to the toggle fixing portion via a first rotary shaft, a second member coupled to the first member via a second rotary shaft, and coupled to the movable mold attachment portion via a third rotary shaft, and a third member coupled to the crosshead and coupled to the first member via a fourth rotary shaft, and a length of a line connecting a center of the first rotary shaft and a center of the second rotary shaft in the first member is equal to or longer than a length of a line connecting a center of the second rotary shaft and a center of the third rotary shaft in the second member.

According to such an aspect, compared to when the length of the line connecting the center of the first rotary shaft and the center of the second rotary shaft in the first member is less than the length of the line connecting the center of the second rotary shaft and the center of the third rotary shaft in the second member, the amount of backward movement of the movable mold attachment portion to the amount of backward movement of the crosshead can be reduced. Since the mold clamping force is determined by the amount of backward movement of the movable mold attachment portion, according to such an aspect, the mold clamping force when injection molding of a molded article is performed can precisely be adjusted.

What is claimed is:

1. An injection molding apparatus configured to perform injection molding of a molded article using a molding die configured with a fixed mold and a movable mold, the apparatus comprising:
an injection unit configured to inject a material of the molded article into the molding die;
a mold clamping unit to which the molding die is attached and which is configured to perform mold clamping of the molding die; and
a controller configured to control the injection unit and the mold clamping unit, wherein
the mold clamping unit includes
a toggle fixing portion,
a fixed mold attachment portion to which the fixed mold is attached,
a movable mold attachment portion which is disposed between the toggle fixing portion and the fixed mold attachment portion so as to be movable forward and backward in a mold clamping direction, and to which the movable mold is attached,
a motor,
a ball screw attached to the toggle fixing portion and configured to rotate due to driving of the motor,
a crosshead configured to move between the toggle fixing portion and the movable mold attachment portion due to rotation of the ball screw, and
a toggle section coupled to the toggle fixing portion, the movable mold attachment portion, and the crosshead and configured to move the movable mold attachment portion along the mold clamping direction due to a movement of the crosshead,
the toggle section includes
a first member coupled to the toggle fixing portion via a first rotary shaft,
a second member coupled to the first member via a second rotary shaft, and coupled to the movable mold attachment portion via a third rotary shaft, and
a third member coupled to the crosshead and coupled to the first member via a fourth rotary shaft, and
a length of a line connecting a center of the first rotary shaft and a center of the second rotary shaft in the first member is equal to or longer than a length of a line connecting a center of the second rotary shaft and a center of the third rotary shaft in the second member.

2. The injection molding apparatus according to claim 1, wherein
the toggle fixing portion includes a recess into which at least a part of the crosshead is fitted.

3. The injection molding apparatus according to claim 2, wherein
at least a part of the crosshead is fitted into the recess when the crosshead is located closest to the toggle fixing portion.

4. The injection molding apparatus according to claim 1, wherein
the toggle fixing portion includes
a fixing plate, and
a coupling portion disposed so as to protrude from the fixing plate toward the mold clamping direction and coupled to the first member via the first rotary shaft, and
a length of a line connecting an end portion of the coupling portion in contact with the fixing plate and the center of the first rotary shaft is longer than the length of the line connecting the center of the first rotary shaft and the center of the second rotary shaft in the first member.

5. The injection molding apparatus according to claim 1, wherein
the ball screw includes
a screw shaft, and
a nut disposed so as to be movable along the screw shaft and coupled to the crosshead, and
a part of the nut protrudes toward the toggle fixing portion with respect to the crosshead and does not protrude toward the movable mold attachment portion with respect to the crosshead.

6. The injection molding apparatus according to claim 1, wherein
the mold clamping unit includes
a fixing plate moving section configured to move the toggle fixing portion along the mold clamping direction, and
the controller controls the fixing plate moving section to move the toggle fixing portion to adjust mold clamping force.

7. A mold clamping device comprising:
a toggle fixing portion;
a fixed mold attachment portion to which a fixed mold a position of which is fixed in a mold clamping operation is attached;
a movable mold attachment portion which is disposed between the toggle fixing portion and the fixed mold attachment portion so as to be movable forward and backward in a mold clamping direction, and to which a movable mold which is moved relatively to the fixed mold in the mold clamping operation is attached;
a motor;
a ball screw attached to the toggle fixing portion and configured to rotate due to driving of the motor;
a crosshead configured to move between the toggle fixing portion and the movable mold attachment portion due to rotation of the ball screw; and
a toggle section coupled to the toggle fixing portion, the movable mold attachment portion, and the crosshead and configured to move the movable mold attachment portion along the mold clamping direction due to a movement of the crosshead, wherein
the toggle section includes
a first member coupled to the toggle fixing portion via a first rotary shaft,
a second member coupled to the first member via a second rotary shaft, and coupled to the movable mold attachment portion via a third rotary shaft, and
a third member coupled to the crosshead and coupled to the first member via a fourth rotary shaft, and
a length of a line connecting a center of the first rotary shaft and a center of the second rotary shaft in the first member is equal to or longer than a length of a line connecting a center of the second rotary shaft and a center of the third rotary shaft in the second member.
